(19) United States
(12) Patent Application Publication
(10) Pub. No.: US 2024/0316778 A1
(43) Pub. Date: Sep. 26, 2024

(54) SYSTEM AND METHOD FOR MONITORING A HAZARDOUS ZONE OF A MACHINE

(71) Applicant: SICK AG, Waldkirch (DE)

(72) Inventors: Markus HAMMES, Waldkirch (DE); Christoph HOFMANN, Waldkirch (DE)

(21) Appl. No.: 18/611,352

(22) Filed: Mar. 20, 2024

(30) Foreign Application Priority Data
Mar. 22, 2023 (DE) 102023107215.3

(51) Int. Cl. B25J 9/16; B25J 19/02

(52) U.S. Cl. CPC B25J 9/1676; B25J 19/022; B25J 19/023

(57) ABSTRACT

A system and a method for monitoring a hazardous zone of a machine comprising at least one sensor having a spatial monitored zone for monitoring the hazardous zone and a control and evaluation unit, wherein the sensor is configured to cyclically transmit 3D data of the monitored zone to the control and evaluation unit, wherein the sensor is further configured to generate at least one protected zone in the monitored zone, wherein the control and evaluation unit is configured to compare the received 3D data of the monitored zone with known position data of the machine and to check them for agreement, wherein the control and evaluation unit is configured to localize objects in the monitored zone of the sensor with reference to the 3D data and to determine their distance from a dangerous part of the machine, and wherein the control and evaluation unit is configured to bridge the sensor having the protected zone as long as there is an agreement of the position data and not to bridge the sensor having the protected zone if there is no agreement of the position data and not to bridge the sensor having the protected zone if the distance of objects from at least one dangerous part of the machine falls below predefined first distance values.

The present invention relates to a system for monitoring a hazardous zone of a machine and to a method of monitoring a hazardous zone of a machine.

The prior art for the safeguarding of industrial robots is the use of safety laser scanners for zonal safeguarding or of light grids for access safeguarding. In this respect, the presence of a person or of another object in the hazardous zone is detected and the dangerous movement of the robot is shut down.

A distance and speed monitoring represents a higher development stage of this known approach in which a robot is initially slowed down in dependence on the distance between a person and a robot and in dependence on the approach speed, which represents a risk reduction and is only stopped on a falling below of a further approach threshold. Alternatively, the robot is diverted into free zones to avoid a hazard.

A disadvantage of the approach that pursues a simple presence detection and, resulting from this, a safe shutdown is the great restriction in productivity. Whenever the approach of a person is required, the robot has to wait in a stationary manner until the person has left again.

An object of the invention comprises providing an improved system and an improved method in which persons may dwell in the hazardous zone and a safe shutdown of the machine nevertheless takes place if a danger to the person could occur.

The object is satisfied by a system for monitoring a hazardous zone of a machine comprising at least one sensor having a spatial monitored zone for monitoring the hazardous zone and having a control and evaluation unit, wherein the sensor is configured to cyclically transmit 3D data of the monitored zone to the control and evaluation unit, wherein the sensor is further configured to generate at least one protected zone in the monitored zone, wherein the control and evaluation unit is configured to compare the received 3D data of the monitored zone with known position data of the machine and to check them for agreement, wherein the control and evaluation unit is configured to localize objects in the monitored zone of the sensor with reference to the 3D data and to determine their distance from a dangerous part of the machine, and wherein the control and evaluation unit is configured to bridge the sensor having the protected zone as long as there is an agreement of the position data and not to bridge the sensor having the protected zone if there is no agreement of the position data and not to bridge the sensor having the protected zone if the distance of objects from at least one dangerous part of the machine falls below predefined first distance values.

The object is further satisfied by a method of monitoring a hazardous zone of a machine comprising at least one sensor having a spatial monitored zone for monitoring the hazardous zone and having a control and evaluation unit, wherein the sensor cyclically transmits 3D data of the monitored zone to the control and evaluation unit, wherein the sensor generates a protected zone in the monitored zone, wherein the control and evaluation unit compares the received 3D data of the monitored zone with known position data of the machine and checks them for agreement, wherein the control and evaluation unit localizes objects in the monitored zone of the sensor with reference to the 3D data and determines their distance from a dangerous part of the machine, and wherein the control and evaluation unit bridges the sensor having the protected zone as long as there is an agreement of the position data and does not bridge the sensor having the protected zone if there is no agreement of the position data and does not bridge the sensor having the protected zone if the distance of objects from at least one dangerous part of the machine falls below predefined first distance values.

In accordance with the invention, it is made possible to implement an improved distance and speed monitoring with the aid of muting, i.e. a bridging or a conditional bridging of a safeguarding function of the machine.

The following system components are used for this:
A, for example, unsafe control and evaluation unit or a control unit that is configured to compare 3D image data of the hazardous zone of the sensor with the known position data of the robot and to check them for agreement.

The control and evaluation unit is additionally configured to localize further objects in the field of view of the sensor with reference to the 3D data of the sensor and to determine their distance from the robot. These functions do not, however, have to be carried out in accordance with the requirements of functional safety.

One or, for example, more sensors, in particular 3D sensors, are preferably safety certified. They detect 3D data of the hazardous zone in real time and with synchronization information and deliver the data to the control and evaluation unit.

The sensor, for example a safe 3D camera having an integrated protected zone function, is configured for a classical monitoring of the approach zone around the machine.

It may be advantageous to use a safe controller for binary switch signals as the control and evaluation unit to combine activation signals or bridging signals and the signal of the sensor.

The basic idea of the invention is that the actual safeguarding of the machine takes place with the aid of a simple protected zone function of the sensor or safety sensor. This means that on the presence of a person in the protected zone, a shutdown signal is sent to the machine or to its controller or to its machine controller. This safeguarding is proven and can be implemented with high reliability. It is called a primary safety function in the following.

In addition to this safeguarding, the remaining system parts deliver a function that generates a signal for the deactivation or bridging of the primary safety function in dependence on the situation and in dependence on the agreement and plausibility of the remaining information (3D data and machine position data).

The sensor or sensors or 3D sensors specifically deliver(s) information or 3D data on the environment of the machine that is used in two different ways.

A check is made in these 3D data whether the zones in which moving parts of the machine should be located according to the machine controller are also occupied by an object in the 3D data or in the 3D image. This can be checked, for example, with location exactness by a so-called voxel grid approach. In this process, volume pixels are formed, with one pixel or voxel corresponding to one point in space. This partial function serves for the plausibilization and forms an effective check of the error-free function of the sensor and of the machine controller.

In addition to this, stationary objects in the monitored zone can continue to be used in the same manner for plausibilization, for example the floor that is detected by the sensor. Since a specific expectation is checked here in which the random agreement can be precluded in the case of error and since it is here a simple deactivation signal or muting signal, it is sufficient in the simplest case to use an unsafe control and evaluation unit or an unsafe controller for the check.

Additional simple mechanisms such as a synchronization check or a check of cyclic monitoring signals (colloquially heartbeat signals) can be added.

If these plausibility checks result in the lack of agreement of the expectation and the detected situation at any point in time, the deactivation signal or bridging signal is canceled and the primary safety function can shut down the machine in the presence of a person. It is a particular advantage of this approach that the machine is not stopped directly on an incorrectly recognized irregularity of the plausibility function, but rather only when a human is actually in the vicinity of the dangerous movement of the machine.

This increases the availability of the complex safeguarding. Conversely, a primary safety function that is based on a direct evaluation of the 3D data would possibly generate incorrect shutdowns more frequently due to the high complexity. The approach described here prevents incorrect shutdowns.

The distance between the person and the dangerous part of the machine is additionally determined in the 3D data. For example with said voxel grid approach according to which points in space are determined or, for example, according to different methods. On a falling below of a specified distance threshold, the deactivation signal or bridging signal is deleted and the primary safety function shuts down the machine.

A further advantage of this inverted safety logic with the applied deactivation signal or muting signal is that a response time of the safety measures is not limited by the response time of the sensor. The shutdown signal of the primary safety function or of the sensor is already present on the presence of a person in the protected zone and is suppressed by the deactivation signal or muting signal. As soon as the deactivation signal or muting signal drops out, the shutdown signal reaches the machine and the machine is stopped immediately.

An approach procedure can run as follows, for example, in summary:
A person approaches the machine and enters the protected zone or the protected field. Without muting in the sense of this invention, the primary safety function would now initiate a shutdown. However, the 3D sensor additionally detects the exact position of the person and bridges the primary safety function if the distance from the hazard site is still sufficiently large. At this point in time, the distance of the person is still large enough that the machine can continue to work. The machine is optionally switched into a mode having a slowed down movement routine, for example. There is an agreement between the position data of the moving part of the machine from the machine controller and the 3D data of the sensor so that a deactivation signal or a bridging signal previously prevents the shutdown of the machine.

The person continues to approach. The sensor or 3D sensor detects the approach that is still uncritical up to now and the control and evaluation unit causes the moving part of the machine to evade backward via the machine controller. The agreement of the 3D data of the sensor and the machine data of the machine controller is still present and the shutdown signal of the primary safety function is still deactivated or bridged.

The person continues to approach and reaches a critical distance zone. The sensor or 3D sensor detects the critical approach and deletes the deactivation signal or bridging signal. The primary shutdown signal reaches the machine and causes the stop of the machine.

All the complex functional parts that the distance and speed monitoring requires are displaced by inverse safety logics into the unsafe part of the system, that is of the unsafe control and evaluation unit.

The system reaches a high safety level: due to the plausibilization of diversely determined information, that is of the 3D data of the sensor and the machine data of the machine controller of the machine, without requiring safe control hardware.

The response time of the primary safety sensor is less relevant with this approach. The shutdown signal is already applied when the deactivation signal or the bridging signal is canceled.

Incorrect shutdowns can only occur at all when both a protected zone infringement is present and the plausibility check in the complex system part fails. The typical connection according to which a complex system would possibly result in more frequent incorrect shutdowns is thus bypassed.

In a further development of the invention, a first sensor is configured as a sensor to cyclically deliver 3D data of the monitored zone to the control and evaluation unit and a second sensor is configured as a sensor to generate the protected zone.

The first sensor can, for example, be a 3D camera, a laser scanner having a protected zone. The 3D camera can be a 3D time of flight camera for example, or a 3D stereo camera, for example.

The second sensor can, for example, be a 3D camera, a laser scanner having a protected zone, or a protected zone. The 3D camera can be a 3D time of flight camera for example, or a 3D stereo camera, for example.

In a further development of the invention, the control and evaluation unit is configured to cause at least a part of the machine to perform an evasive movement or a slowing down if the distance of objects from a dangerous part of the machine falls below predefined second distance values.

In accordance with the further development of the invention, the control and evaluation unit is configured to redirect or to brake the dangerous part of the machine to maintain the productivity of the work routine. The control of the machine is thereby very flexible since this part of the function is not a component of the safety function.

In a further development of the invention, the control and evaluation unit is configured to compare the received 3D data of the monitored zone of the sensor with known position data of the environment and to check them for agreement.

In accordance with the further development, a static environment is taught. Dynamically moving objects such as persons can thus already be detected and tracked more simply.

In a further development of the invention, the control and evaluation unit is configured to compare the received 3D data of the monitored zone of the sensor with position data of further sensors and to check them for agreement. 3D data of the sensor are thus compared with 3D data of further sensors and can thus be plausibilized.

For example, the further sensor can be a time of flight sensor, a laser scanner, a laser scanner having a plurality of scan planes, a time of flight camera, a stereo camera, an FMCW LIDAR sensor, a radar sensor, an ultrawide band radio sensor, or an infrared camera.

Such sensors are suitable to effectively monitor a spatial monitored zone.

Time of flight measurement systems make a distance measurement possible by determining the time difference between the transmission of the light and the return of the light reflected by the measurement object.

The time of flight sensor, for example, works according to a direct time of flight process (dTOF), according to which brief light pulses or light pulse groups are transmitted and the time up to the reception of a remission or reflection of the light pulses at an object is measured. The light signals are here formed by light pulses.

However, other time of flight processes are also possible, for example the phase process, according to which transmitted light is amplitude modulated and a phase shift between the transmitted light and the received light is determined, with the phase shift likewise being a measure for the time of flight (indirect time of flight process, iTOF).

Furthermore, a CW (continuous wave) process can be used, with a light signal being used which is constant in time. In this process, for example, the single photon events are distributed via a gating signal into two counters and a phase is calculated from the ratio of the counts.

A 3D camera, for example, monitors a monitored zone by means of a plurality of detected distance values. A 3D camera has the advantage that a volume-like protected zone can be simply monitored.

A stereo camera, for example, monitors the monitored zone by means of a plurality of detected distance values. The distance values are determined on the basis of the two cameras of the stereo camera that are installed at a basic spacing from one another. A stereo camera equally has the advantage that a volume-like protected zone can be monitored.

Distance values on the basis of the measured time of flight that are determined by an image sensor are determined by means of a time of flight camera. A time of flight camera equally has the advantage that a volume-like protected zone can be monitored.

The radar sensors, for example, form spatial monitored zones for the monitoring of the protected zone. The protected zones can have practically any desired geometries. For example, the protected zones starting from the radar sensor housing are conical or lobe-shaped for spatial protected zones. An opening angle of a protected zone amounts to +/−60°, for example. Smaller or larger opening angles are also provided. However, with a sensor having more than one reception antenna and/or transmission antenna, rectangular protected zones or parallelepiped-shaped protected zones can also be formed.

The or each radar sensor, for example, emits radar waves by the reception antenna in the frequency range from 40 GHz to 125 GHZ. The frequency band of the radar sensor can here be smaller than the indicated frequency range.

The sensor is an ultrawide band sensor, for example. The ultrawide band radio sensor in particular forms an ultrawide band radio location system, with the frequency used being in the range from 3.1 GHZ to 10.6 GHz, with the transmission energy amounting to a maximum of 0.5 mW per radio station.

An absolute bandwidth in an ultrawide band radio location system amounts to at least 500 MHz or a relative bandwidth amounts to at least 20% of the central frequency.

The range of such a radio location system amounts, for example, to 0 to 50 m. In this respect, the short time duration of the radio pulses is used for the localization.

The radio location system thus only transmits radio waves having a low energy. The system can be used very flexibly and has no interference.

In a further development of the invention, the control and evaluation unit is configured to activate the protected zone when the dangerous part of the machine is in an unpermitted position.

This plausibility check can be expanded to the extent that the position of the parts of the machine is also compared with previously configured unpermitted positions or unpermitted zones, so-called “no-go areas”. It can be prevented in this manner that parts of the machine are at positions where they may not be. It is also advantageous here that shutdowns only take place when a person actually approaches. The productivity of the plant is thus increased.

In a further development of the invention, the machine is a mobile machine or a fixed position machine.

The fixed position can, for example, be a press, a machine tool, an assembly machine, or similar. The fixed position machines have a fixed position part and at least one moving part, with the moving part being able to carry out a dangerous movement.

The mobile machine can, for example, be an automated guided vehicle, a driverless vehicle, or an autonomously driving robot.

In a further development of the invention, the machine is a robot and the hazardous zone of the machine is a hazardous zone of the robot.

The robot can, for example, be a multiaxial robot, for example an installation robot in a production line.

The invention will also be explained in the following with respect to further advantages and features with reference to the enclosed drawing and embodiments. The Figures of the drawing show in:

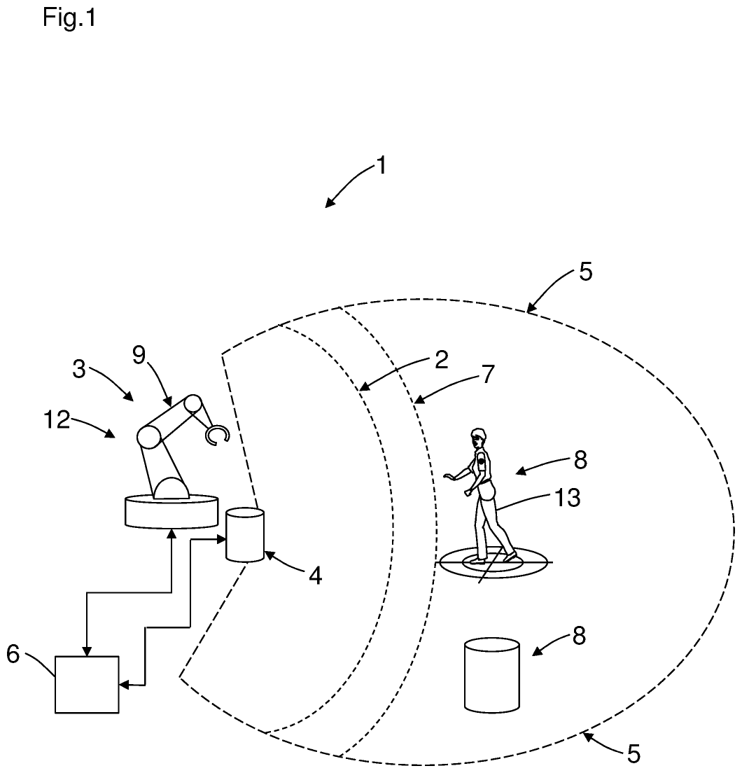

FIGS. 1 to 4 respectively, a system for monitoring a hazardous zone.

In the following Figures, identical parts are provided with identical reference numerals.

FIG. 1 shows a system 1 for monitoring a hazardous zone 2 of a machine 3 comprising at least one sensor 4 having a spatial monitored zone 5 for monitoring the hazardous zone 2 and having a control and evaluation unit 6, wherein the sensor 4 is configured to cyclically transmit 3D data of the monitored zone 5 to the control and evaluation unit 6, wherein the sensor 4 is further configured to generate at least one protected zone 7 in the monitored zone 5, wherein the control and evaluation unit 6 is configured to compare the received 3D data of the monitored zone 5 with known position data of the machine 3 and to check them for agreement, wherein the control and evaluation unit 6 is configured to localize objects 8 in the monitored zone 5 of the sensor 4 with reference to the 3D data and to determine their distance from a dangerous part 9 of the machine 3, and wherein the control and evaluation unit 6 is configured to bridge the sensor 4 having the protected zone 7 as long as there is an agreement of the position data and not to bridge the sensor 4 having the protected zone 7 if there is no agreement of the position data and not to bridge the sensor 4 having the protected zone 7 if the distance of objects 8 from at least one dangerous part 9 of the machine 3 falls below predefined first distance values.

The machine 3 is, for example, a robot 12 and the hazardous zone 2 of the machine 3 is a hazardous zone 2 of the robot 12.

The robot 12 can, for example, be a multiaxial robot 12, for example an installation robot in a production line.

The machine 3 is, for example, a mobile machine or a fixed position machine.

It is made possible to implement an improved distance and speed monitoring with the aid of muting, i.e. a bridging or conditional of a safeguarding function of the robot 12.

The following system components are used for this:
A, for example, unsafe control and evaluation unit 6 or a control unit that is configured to compare 3D image data of the monitored zone 3 of the sensor 4 with the known position data of the robot 12 and to check them for agreement.

The control and evaluation unit 6 is additionally configured to localize further objects 8 in the field of view of the sensor 4 with reference to the 3D data of the sensor 4 and to determine their distance from the robot 12. These functions do not, however, have to be carried out in accordance with the requirements of functional safety.

One or, for example, more sensors 4, in particular 3D sensors, are preferably safety certified. They detect 3D data of the monitored zone, protected zone, or hazardous zone in real time and with synchronization information and deliver the data to the control and evaluation unit 6.

The sensor 4, for example a safe 3D camera having an integrated protected zone function, is configured for a classical monitoring of the approach zone around the robot 12.

It may be advantageous to use a safe controller for binary switch signals as the control and evaluation unit 6 to combine activation signals or bridging signals and the signal of the sensor 4.

The basic idea is that the actual safeguarding of the robot 12 takes place with the aid of a simple protected zone function of the sensor 4 or safety sensor. This means that on the presence of a person 13 as an object 8 in the protected zone 7, a shutdown signal is sent to the robot 12 or to its controller or to its machine controller. This safeguarding is proven and can be implemented with high reliability. It is called a primary safety function in the following.

In addition to this safeguarding, the remaining system parts deliver a function that generates a signal for the deactivation or bridging of the primary safety function in dependence on the situation and in dependence on the agreement and plausibility of the remaining information (3D data and machine position data).

The sensor or sensors 4 or 3D sensors specifically deliver(s) information or 3D data on the environment of the robot 12 that is used in two different ways.

A check is made in these 3D data whether the zones in which moving parts 9 of the robot should be located according to the robot controller are also occupied by an object 8 in the 3D data or in the 3D image. This partial function serves for the plausibilization and forms an effective check of the error-free function of the sensor 4 and of the robot controller.

In addition to this, stationary objects 8 in the monitored zone 5 can continue to be used in the same manner for plausibilization, for example the floor that is detected by the sensor 4. Since a specific expectation is checked here in which the random agreement can be precluded in the case of error and since it is here a simple deactivation signal or muting signal, it is sufficient in the simplest case to use an unsafe control and evaluation unit 6 or an unsafe controller for the check.

Additional simple mechanisms such as a synchronization check or a check of cyclic monitoring signals can be added.

If these plausibility checks result in the lack of agreement of the expectation and the detected situation at any point in time, the deactivation signal or bridging signal is canceled and the primary safety function can shut down the robot 12 in the presence of a person 13. The robot 12 is thus not stopped directly on an incorrectly recognized irregularity of the plausibility function, but rather only when a human is actually in the vicinity of the dangerous movement of the robot.

The distance between the person 13 or the object 8 and the dangerous part of the robot 12 is additionally determined in the 3D data. On a falling below of a specified distance threshold, the deactivation signal or bridging signal is deleted and the primary safety function shuts down the robot 12.

The shutdown signal of the sensor 4 is already present and is suppressed by the deactivation signal or muting signal. As soon as the deactivation signal or muting signal drops out, the shutdown signal reaches the robot 12 and the robot 12 is stopped immediately.

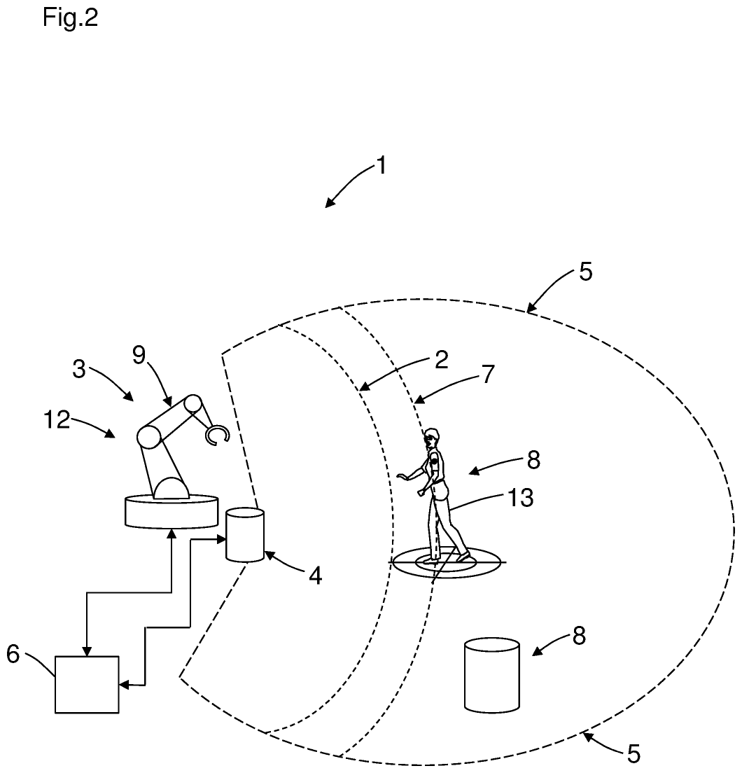

An approach procedure can run as follows, for example, in summary:
A person 13 approaches the robot 12 in accordance with FIG. 2 and enters the protected zone 7. At this point in time, the distance of the person 13 is still large enough that the robot 12 can continue to work. The robot 12 is optionally switched into a mode having a slowed down movement routine, for example. There is an agreement between the position data of the moving part 9 of the robot 12 from the machine controller and the 3D data of the sensor 4 so that a deactivation signal or a bridging signal previously prevents the shutdown of the robot 12.

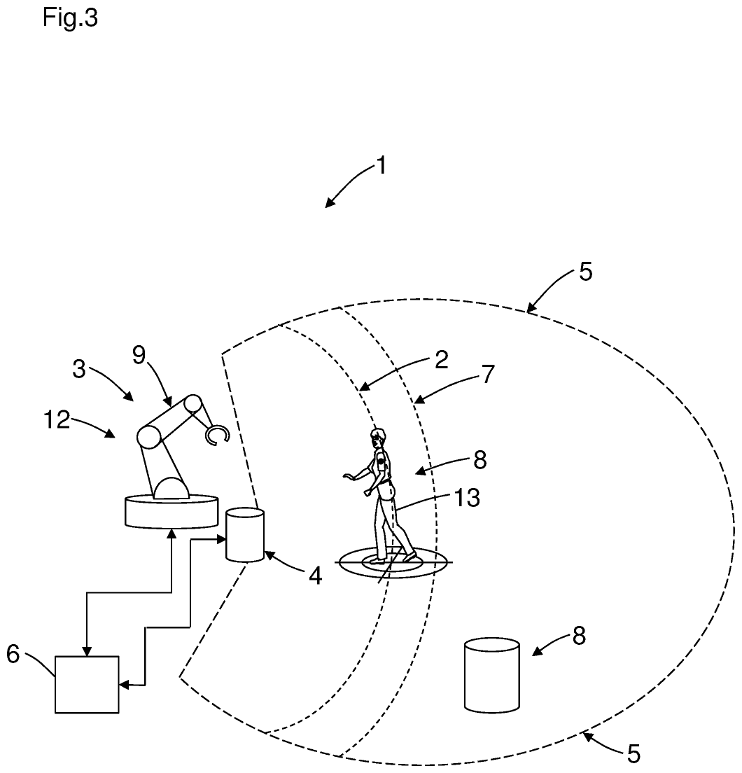

The person 13 continues to approach in accordance with FIG. 3. The sensor 4 or 3D sensor detects the approach that is still uncritical up to now and the control and evaluation unit 6 causes the moving part 9 of the robot 12 to evade backward via the robot controller. The agreement of 3D data of the sensor 4 and robot data of the robot controller is still present and the shutdown signal of the primary safety function is still deactivated or bridged.

The person 13 continues to approach and reaches a critical distance zone. The sensor 4 or 3D sensor detects the critical approach and deletes the deactivation signal or bridging signal. The primary shutdown signal reaches the robot 12 and causes the stop of the robot 12.

All the complex functional parts that the distance and speed monitoring requires are displaced by inverse safety logic into the unsafe part of the system 1, that is of the unsafe control and evaluation unit 6.

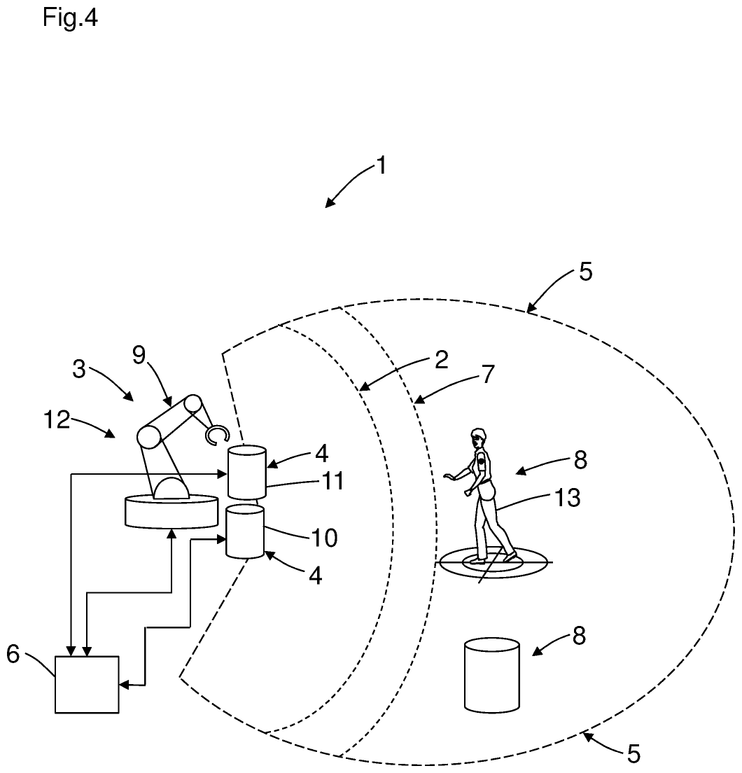

In accordance with FIG. 4, for example, a first sensor 10 is configured as a sensor 4 to cyclically deliver 3D data of the monitored zone 5 to the control and evaluation unit 6 and a second sensor 11 is configured as a sensor 4 to generate the protected zone 7.

The first sensor 10 can, for example, be a 3D camera, a laser scanner having a protected zone. The 3D camera can be a 3D time of flight camera for example, or a 3D stereo camera, for example.

The second sensor 11 can, for example, be a 3D camera, a laser scanner having a protected zone, or a protected zone. The 3D camera can be a 3D time of flight camera for example, or a 3D stereo camera, for example.

For example, the control and evaluation unit 6 is configured to cause at least a part 9 of the robot 12 to perform an evasive movement or a slowing down if the distance of objects 8 from a dangerous part 9 of the robot falls below predefined second distance values.

For example, the control and evaluation unit 6 is configured to redirect or to slow down the dangerous part 9 of the robot to maintain productivity of the work routine. The control of the machine is thereby very flexible since this part of the function is not a component of the safety function.

For example, the control and evaluation unit 6 is configured to compare the received 3D data of the monitored zone 5 with known position data of the environment and to check them for agreement.

A static environment is taught, for example. Dynamically moving objects 8 such as persons 13 can thus already be detected and tracked more simply.

For example, the control and evaluation unit 6 is configured to activate the protected zone 7 when the dangerous part 9 of the robot 12 is in an unpermitted position.

This plausibility check can be expanded to the extent that the position of the parts 9 of the robot 12 is also compared with previously configured unpermitted positions or unpermitted zones. It can be prevented in this manner that parts 9 of the robot are at positions where they may not be. It is also advantageous here that shutdowns only take place when a person 13 actually approaches. The productivity of the plant is thus increased.

### REFERENCE NUMERALS

1 system
2 hazardous zone
3 machine
4 sensor
5 spatial monitored zone
6 control and evaluation unit
7 protected zone
8 objects
9 dangerous part of the machine
10 first sensor
11 second sensor
12 robot
13 person

1. A system for monitoring a hazardous zone of a machine, comprising at least one sensor having at least one spatial monitored zone for monitoring the hazardous zone;
and a control and evaluation unit;
wherein the sensor is configured to cyclically transmit 3D data of the monitored zone to the control and evaluation unit;
wherein the sensor is further configured to generate at least one protected zone in the monitored zone;
wherein the control and evaluation unit is configured to compare the received 3D data of the monitored zone with known position data of the machine and to check them for agreement;
wherein the control and evaluation unit Is configured to localize objects in the monitored zone of the sensor with reference to the 3D data and to determine their distance from the dangerous part of the machine,
wherein the control and evaluation unit is configured to bridge the sensor having the protected zone as long as there is an agreement of the position data; and
not to bridge the sensor having the protected zone if there is no agreement of the position data;
and not to bridge the sensor having the protected zone if the distance of objects from at least one dangerous part of the machine falls below predefined first distance values.

2. The system in accordance with claim 1, wherein a first sensor is configured as a sensor to cyclically deliver 3D data of the monitored zone to the control and evaluation unit and a second sensor is configured as a sensor to generate the protected zone.

3. The system in accordance with claim 1, wherein the control and evaluation unit is configured to cause at least a part of the machine to carry out an evasive movement if the distance of objects from a dangerous part the machine falls below predefined second distance values.

4. The system in accordance with claim 1, wherein the control and evaluation unit is configured to compare the received 3D data of the monitored zone of the sensor with known position data of the environment and to check them for agreement.

5. The system in accordance with claim 1, wherein the control and evaluation unit is configured to compare the received 3D data of the monitored zone of the sensor with position data of further arranged sensors and to check them for agreement.

6. The system in accordance with claim 1, wherein the control and evaluation unit is configured to activate the protected zone when the dangerous part of the machine is in an unpermitted position.

7. The system in accordance with claim 1, wherein the machine is a mobile machine or a fixed position machine.

8. The system in accordance with claim 1, wherein the machine is a robot and the hazardous zone of the machine is a hazardous zone of the robot.

9. A method of monitoring a hazardous zone of a machine, comprising at least one sensor having at least one spatial monitored zone for monitoring the hazardous zone;
and a control and evaluation unit;
wherein the sensor cyclically transmits 3D data of the monitored zone to the control and evaluation unit;
wherein the sensor generates at least one protected zone in the monitored zone;
wherein the control and evaluation unit compares the received 3D data of the monitored zone with known position data of the machine and compares them for agreement;
wherein the control and evaluation unit localizes objects in the monitored zone of the sensor with reference to the 3D data and determines their distance from a dangerous part of the machine,
wherein the control and evaluation unit bridges the sensor having the protected zone as long as there is an agreement of the position data;
and does not bridge the sensor having the protected zone if there is no agreement of the position data;
and does not bridge the sensor having the protected zone if the distance of objects from at least one dangerous part of the machine falls below predefined first distance values.
